(19) United States
(12) Patent Application Publication
(10) Pub. No.: US 2026/0030526 A1
(43) Pub. Date: Jan. 29, 2026

(54) MANAGING CHANNEL CARDS OF DATA PROCESSING SYSTEMS USING AN INFERENCE MODEL

(71) Applicant: Dell Products L.P., Round Rock, TX (US)

(72) Inventors: DEEPAGANESH PAULRAJ, Bangalore (IN); VINOD PARACKAL SABY, Bangalore (IN)

(21) Appl. No.: 18/785,299

(22) Filed: Jul. 26, 2024

(51) Int. Cl. G06N 5/04; H04L 9/40

(52) U.S. Cl. CPC G06N 5/04; H04L 63/18

(57) ABSTRACT

Methods and systems for managing operation of a data processing system are disclosed. Channel cards of the data processing system may be non-standard channel cards that perform non-standard functions. If a channel card is a non-standard channel card, it may be determined whether to any modifications are to be made to the data processing system to facilitate cooperative operation of the hardware resources with respect to the non-standard channel card. To do so, typification data for the data processing system and typification data for the channel card may be obtained and used as ingest for an inference model trained to generate operation update tasks. The operation update tasks may include modifications to configurations of the channel card and/or modifications to configurations of the data processing system. The operation update tasks may be implemented to obtain an updated system and the updated system may be used to provide computer-implemented services.

### FIELD

Embodiments disclosed herein relate generally to managing operation of data processing systems. More particularly, embodiments disclosed herein relate to systems and methods to manage channel cards of data processing systems using an inference model.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIG. 1B shows a block diagram illustrating components of a data processing system in accordance with an embodiment.

FIG. 1C shows a block diagram illustrating hardware resources of a data processing system in accordance with an embodiment.

FIG. 2 shows an interaction diagram in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing system may provide computer-implemented services. To provide the computer-implemented services, hardware resources of the data processing system such as memory modules, processors, channel cards, etc., may operate in cooperation with one another.

For example, a processor of the data processing system may interact with a channel card of the data processing system to facilitate provision of the computer-implemented services. The channel card may include, for example, a graphics card (e.g., a graphics processing unit (GPU)), a sound card, a storage card, and/or other types of hardware components of the data processing system that may be added, removed and/or replaced.

Over time (e.g., after a user obtains the data processing system from the manufacturer), stock hardware components of the data processing system (e.g., hardware components added at the time of manufacturing by the manufacturer of the data processing system) may be modified. For example, the user may replace a stock channel card of the data processing system with an aftermarket (e.g., non-standard) channel card.

The stock channel card may include standard functions (e.g., known functionality, based on a current or preceding industry standard for a class of the channel card). The aftermarket channel card may include the standard functions and non-standard functions. The non-standard functions may be additional to those of the industry standard (e.g., functionality not known by the other stock hardware components).

However, modification of a stock hardware component may adversely impact the cooperative operation of the hardware resources and, subsequently, provision of the computer-implemented services to the user. For example, if a stock channel card is replaced with a channel card that is a non-standard channel card, the channel card and/or the data processing system may not be configured to perform the cooperative operations. Therefore, operable connection of the aftermarket channel card to the data processing system may result in: (i) inefficient utilization of computing resources during operation, (ii) incompatible communication protocols between the channel card and other hardware components of the data processing system, (iii) unexpected changes to thermal conditions and/or power usage by the data processing system, (iv) unexpected security vulnerabilities, and/or (v) other undesirable operating conditions. Such operating conditions may increase a likelihood of errors occurring for the channel card and/or the other hardware components and, subsequently, computer-implemented services based, at least in part, on functionality of the channel card may be adversely impacted.

To overcome the above-discussed challenges, a management controller of the data processing system may provide typification data for the channel card (e.g., numbers and types of hardware components of the channel card, functions performed by the channel card) and typification data for the data processing system (e.g., numbers and types of hardware components of the data processing system, functions performed by the data processing system) to a remote system. The remote system may obtain operation update tasks using the typification data and an inference model, the operation update tasks being usable to place the data processing system and/or channel card in an operating state that increases a likelihood of providing the desired computer-implemented services.

Thus, an improved system may be obtained where updates may be made to improve cooperative operation of hardware components of the data processing system with respect to an aftermarket (e.g., non-standard) channel card. Doing so may increase a quality and/or reliability of the computer-implemented services provided to a user of the data processing system, the computer-implemented services being based, at least in part, on the cooperative operation.

In an embodiment, a method for managing operation of a data processing system is provided. The method may include: obtaining, from a management controller of the data processing system via an out-of-band communication channel, typification data for a channel card of the data processing system and typification data for the data processing system, the channel card being a non-standard channel card; obtaining, using the typification data for the channel card, the typification data for the data processing system and an inference model, operation update tasks for the data processing system, wherein the inference model is based on historic operation information for other data processing systems that hosted other channel cards of a similar typification to a typification of the channel card; updating, using the operation update tasks, operation of the data processing system and/or the channel card to obtain an updated system; and providing computer-implemented services using the updated system.

The historic operation information may include: a first portion for one of the other data processing systems after the one of the other data processing systems updated its operation based on other operation update tasks.

The first portion may include: (i) memory consumption history for the channel card, (ii) central processing unit consumption history for the channel card, (iii) power utilization history for the channel card, (iv) thermal dynamics history for the channel card, (v) error history for the channel card, (vi) security vulnerability history for the channel card, (vii) current configurations of the channel card.

The typification data for the channel card may be usable to cluster channel cards from different manufacturers into clusters of channel cards, and each of the clusters of channel cards may be likely to respond in a same manner to the operation update tasks.

The typification data may include numbers and types of hardware components of the channel card.

The typification data may include an enumeration of functions provided by the channel card.

The updating may be performed by the management controller via sideband channels of the data processing system.

The operation update tasks may be provided to the management controller by a remote system via the out-of-band communication channel.

The management controller may be separate from and tasked with managing operation of hardware resources of the data processing system and the hardware resources may include the channel card.

The data processing system may include a network module adapted to separately advertise network endpoints for the management controller and hardware resources of the data processing system. The network endpoints may be usable by a remote system to address communications to the hardware resources using an in-band communication channel and the management controller using the out-of-band communication channel.

The management controller and the network module may be on separate power domains from the hardware resources so that the management controller and the network module may be operable while the hardware resources are inoperable.

The out-of-band communication channel may run through the network module, and an in-band communication channel that services the hardware resources may also run through the network module.

The network module may host a transmission control protocol/internet protocol (TCP/IP) stack to facilitate network communications via the out of band communication channel.

The non-standard channel card may be configured to perform at least one non-standard function based on standard functions of a class of the channel card.

A non-transitory media may include instructions that when executed by a processor cause the computer-implemented method to be performed.

A data processing system may include the non-transitory media and a processor, and may perform the computer-implemented method when the computer instructions are executed by the processor.

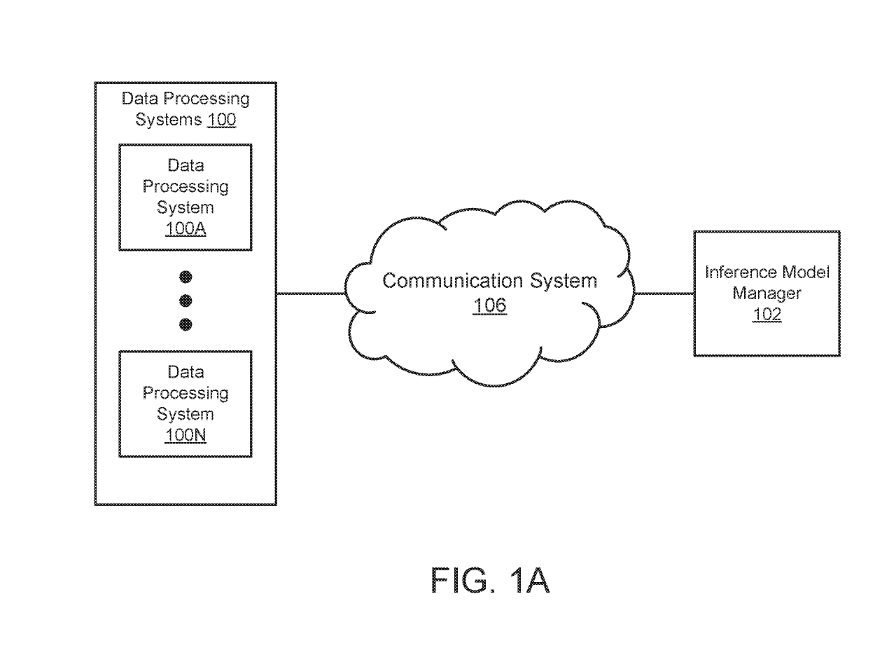

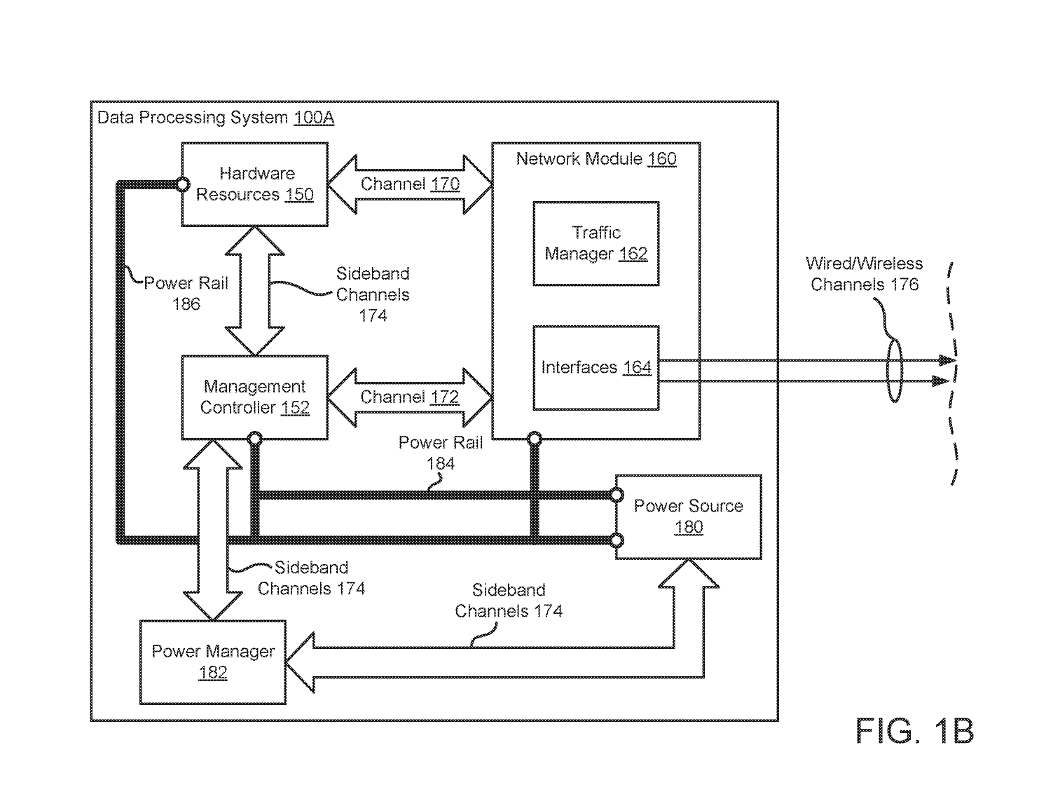

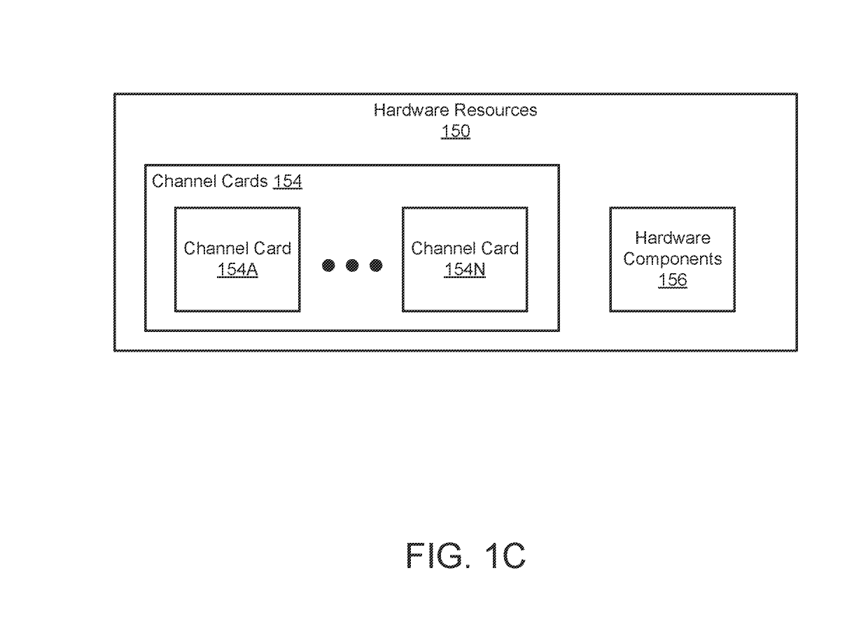

Turning to FIG. 1A, a block diagram illustrating a system in accordance with an embodiment is shown. The system shown in FIG. 1A may provide computer-implemented services. The computer-implemented services may include any type and quantity of computer-implemented services. For example, the computer-implemented services may include data storage services, instant messaging services, database services, data generation services, and/or any other type of service that may be implemented with a computing device. The computer-implemented services may be provided, at least in part, using various hardware components of hardware resources of the data processing system, such as channel cards (e.g., graphics cards, network interface cards (NICs), accelerator cards, expansion cards).

To provide the computer-implemented services, hardware components of the data processing system may interact with one another cooperatively. For example, the computer-implemented services may be based on cooperative interactions between processors, memory modules, storage devices, and/or the channel cards. Based on these interactions, the hardware components may support execution of any number and/or types of software components (e.g., applications hosted by the hardware components), and, in some combination, the hardware and software components may provide for various types of computer-implemented services.

The interactions between the hardware and/or software components may depend on the presence of appropriate firmware, drivers, configuration data, and/or configuration settings of the data processing system that support the cooperative interactions. For example, a channel card of the data processing system may be configured to utilize a portion of resources of the host system (e.g., memory) while providing its functionality. Therefore, the host system (e.g., the other hardware resources and software applications hosted thereon) may be configured to allocate a portion of memory for use by the channel card.

However, over time (e.g., after manufacturing or setup), hardware components such as channel cards may be modified (e.g., by a user). For example, a stock channel card may be replaced with an aftermarket channel card (e.g., a non-standard channel card), and/or aftermarket channel cards may be added to the data processing system. Functionality of the aftermarket channel cards may vary to a high degree depending on their vendor (e.g., manufacturer of the channel card) and/or due to the programmable nature of some channel cards (SmartNICs, data processing unit (DPU) cards, etc.).

For example, channel cards may include programmable platform devices capable of performing various functions in various different ways and/or some may require special methods of communication (e.g., specialized application programming interfaces (APIs)). In other words, some functionality of the channel cards (i) may not adhere to an industry standard for similar types of channel cards, (ii) may be in addition to the functionality specified by the industry standard, and/or (iii) may otherwise require specialized or unusual information to utilize such functions. These functions may be referred to as non-standard functions.

Therefore, a manner of operation of the data processing system with respect to a channel card may be impacted following operable connection of a non-standard channel card (e.g., a channel card with at least one non-standard function) to the data processing system.

For example, the non-standard channel card may be configured to utilize computing resources (e.g., memory) of the host system that the host system has not allocated to the channel card. Therefore, during operation, an attempt by the non-standard channel card to utilize the memory of the host system may lead to: (i) reduced functionality of the non-standard channel card and/or the other hardware components, (ii) errors generated for the non-standard channel card, and/or (iii) other undesirable impacts.

Due to the above-mentioned challenges, errors may occur during operation of the data processing system, potential security vulnerabilities may occur (e.g., due to a lack of knowledge of security requirements for the channel card), and/or other issues may arise. Therefore, a reduction in available functionality and/or an increased likelihood of compromise by a malicious entity may negatively impact the computer-implemented services made available to the user of the data processing system.

In general, embodiments disclosed herein may provide methods, systems, and/or devices for managing operation of data processing systems in a manner that increases a likelihood of providing the computer-implemented services as desired by a downstream consumer of the computer-implemented services (e.g., the user of the data processing system). To do so, an inference model may be utilized to generate operation update tasks for data processing systems operably connected to non-standard channel cards, the operation update tasks being based on a type (e.g., a typification) of the channel card and a type of the data processing system.

To do so, following an identification (e.g., by a startup management entity such as a basic input/output system (BIOS)) that a channel card is a non-standard channel card, a remote system (e.g., an inference model manager) may interact with a management controller of the data processing system to obtain typification data for the channel card (e.g., data usable to infer a type of the channel card) and typification data for the data processing system (e.g., data usable to infer a type of the data processing system). The typification data for the channel card may indicate, for example, numbers and types of hardware components of the channel card, an enumeration of functions provided by the channel card, and/or other data. The typification data for the data processing system may include similar information for the data processing system.

The typification data for the channel card and the typification data for the data processing system may be used as ingest for the inference model, the inference model being based on historic operation information for other data processing systems that hosted other channel cards of a similar typification to a typification of the channel card.

The operation update tasks may be generated by the inference model and may be provided to the management controller via an out-of-band communication channel. By doing so, the management controller may update the operation of the data processing system and/or the non-standard channel card by modifying configurations of hardware and/or software components to improve compatibility between a manner of operation of the channel card and a manner of operation of other hardware components of the data processing system. The compatibility may be based on a degree to which the channel card and/or the data processing system provide desired functions and may be based on operation information such as: (i) computing resource allocation, (ii) compatible communication protocols, (iii) cooperative workload management, (iv) incidences of errors, (v) incidences of security alerts, and/or (vi) other information.

By utilizing out-of-band methods, (e.g., the management controller and the out-of-band communication channel) operation of the data processing system may be managed without the typification data and/or the operation update tasks traversing the in-band hardware components. Consequently, a likelihood of compromise of the operation update tasks may be reduced in the event that one or more of the hardware components is compromised.

To provide the above-mentioned functionality, the system may include data processing systems 100, inference model manager 102, and communication system 106. Data processing systems 100, inference model manager 102, any components thereof and/or any other types of devices or components not shown in FIG. 1A may perform all, or a portion of the computer-implemented services independently and/or cooperatively. Each of these components is discussed below.

Inference model manager 102 may include any number and/or type of systems (e.g., physical devices) that may provide computer-implemented services, such as inference generation services for data processing systems 100. For example, inference model manager 102 may train, host, and/or operate any number of inference models that generate inferences usable, at least in part, to manage operation of data processing systems 100.

Management entities (e.g., management controllers) of data processing systems 100 may interact with inference model manager 102 to obtain operation update tasks (e.g., the inferences) usable to modify operation of data processing systems 100. These interactions may occur in response to an identification of a non-standard hardware component (e.g., a non-standard channel card) being operably connected to a data processing system of data processing systems 100 and/or at other times.

To perform its functionality, inference model manager 102 may: (i) obtain typification data for a channel card (e.g., a non-standard channel card) of a data processing system and typification data for the data processing system, (ii) obtain, using the typification data for the channel card, the typification data for the data processing system, and an inference model, operation update tasks for the data processing system, (iii) provide the operation update tasks to a management controller of the data processing system via an out-of-band communication channel, and/or (iv) perform other tasks.

Inference model manager 102 may manage an inference model repository to store copies of any number of trained inference models and may train new inference models and/or update existing inference models as needed. For example, the inference model may be trained to ingest typification data (e.g., for data processing systems and/or channel cards) and generate inferences indicating operation update tasks for a data processing system. Implementation of the operation update tasks may increase a likelihood that the channel card and/or other hardware components of the data processing system provide functions as desired when operating cooperatively (e.g., via modifying configurations of the channel card and/or other hardware components to increase availability of the functions to users).

To train a new inference model, inference model manager 102 may obtain training data. The training data may include typification data (e.g., of data processing systems, of channel cards, of other hardware components) and labels for the typification data indicating operation update tasks corresponding to the typification data. The new inference model may be trained using other types of training data (e.g., unlabeled data) without departing from embodiments disclosed herein.

To update an existing inference model, inference model manager 102 may monitor data processing systems 100 (e.g., may obtain operation information) via interactions with management controllers of data processing systems 100 and/or management controller agents (e.g., software applications) hosted by hardware components of data processing systems 100. The operation information may include: (i) historic computing resource consumption by the channel card and/or other hardware components, (ii) historic power utilization by the channel card and/or other hardware components, (iii) error history for the channel card and/or other hardware components, (iv) security alerts for the channel card and/or other hardware components, (v) current configurations of the channel card and/or other hardware components, and/or (vi) other information.

Operation information obtained from a data processing system (e.g., 100A) may, therefore, indicate whether operation update tasks previously implemented for data processing system 100A resulted in desired operation of the channel card and/or the other hardware components of data processing system 100A. The operation information may be used as supplementary training data for the inference model and subsequent re-training processes (e.g., partial and/or full re-training processes) may be performed using the updated training data set so that the inference model may be able to learn from ongoing operation of data processing systems 100 when operably connected to non-standard channel cards and/or other types of hardware components.

Data processing systems 100 may include any number and/or type of data processing systems (e.g., 100A-100N). Any of data processing systems 100 may include in-band components (e.g., hardware resources) and out-of-band components (e.g., a management controller, a network module, etc.), and functionality that may allow the out-of-band components to interact with remote systems independently from the in-band components. For more information regarding out-of-band components of data processing systems 100, refer to the discussion of FIG. 1B.

To manage operation of data processing systems 100, out-of-band components such as a management controller of a data processing system (e.g., 100A) may: (i) obtain, via sideband channels, the typification data for the data processing system and the typification data for the channel card from hardware resources of data processing system 100A, (ii) provide, via the out-of-band communication channel, the typification data to a remote system (e.g., inference model manager 102), (iii) receive, via the out-of-band communication channel and from the remote system, the operation update tasks, (iv) update, using the operation update tasks and via the sideband channels, operation of the data processing system and/or operation of the channel card to obtain an updated system, and/or (v) perform other tasks. Refer to FIG. 1B for additional details regarding management controllers.

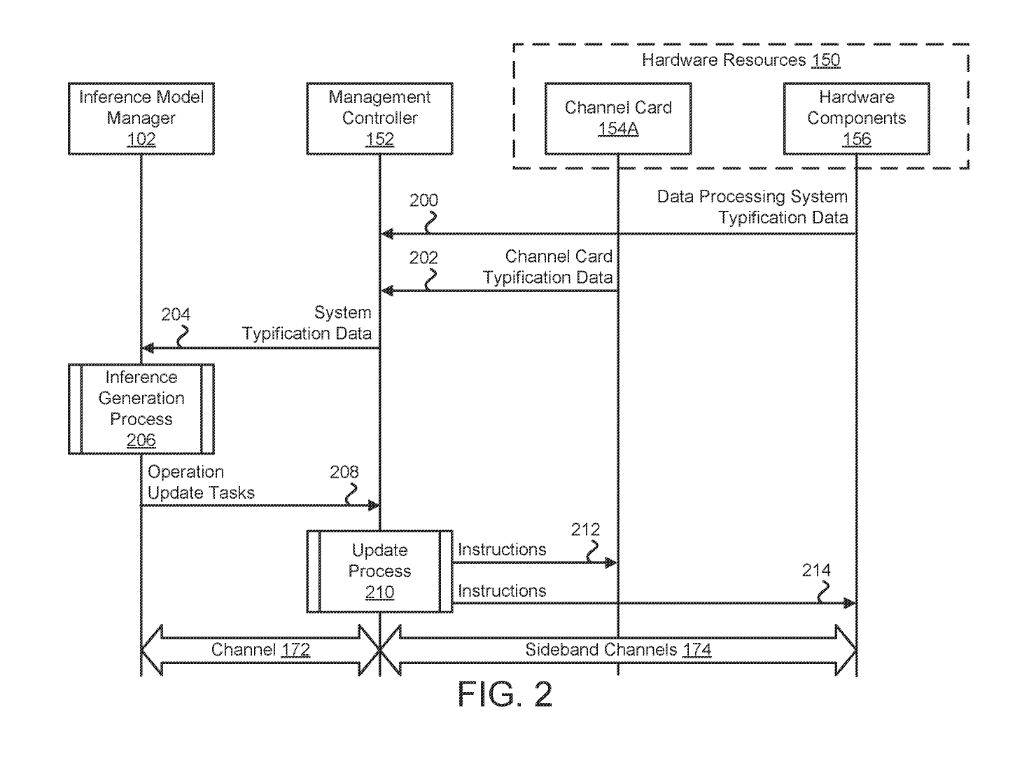

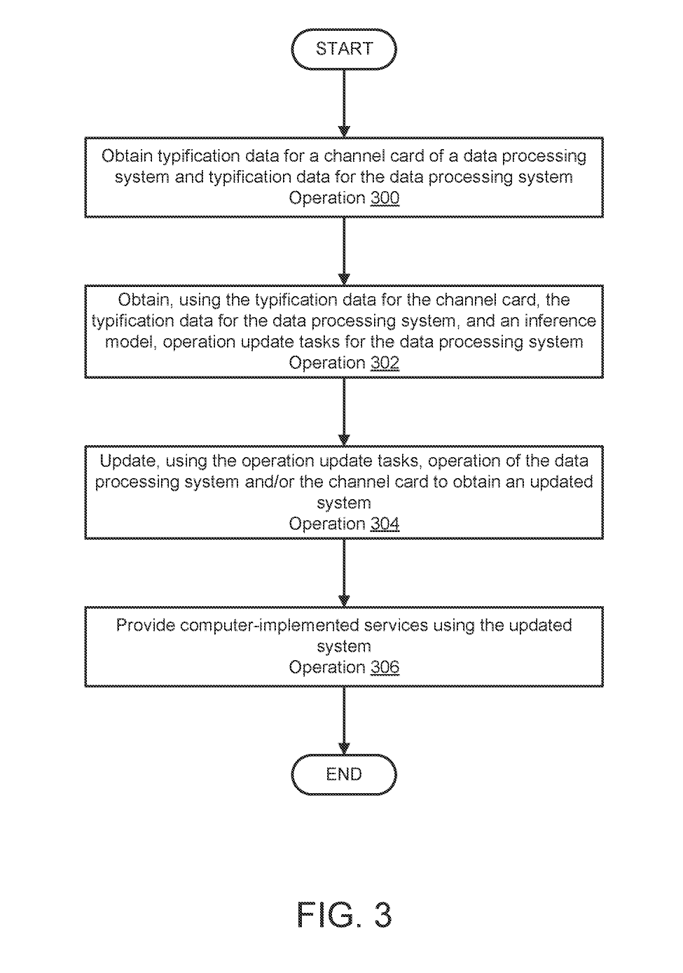

When providing their functionality, any components of the system in FIG. 1A may perform all, or a portion of the actions and methods illustrated in FIGS. 2-3.

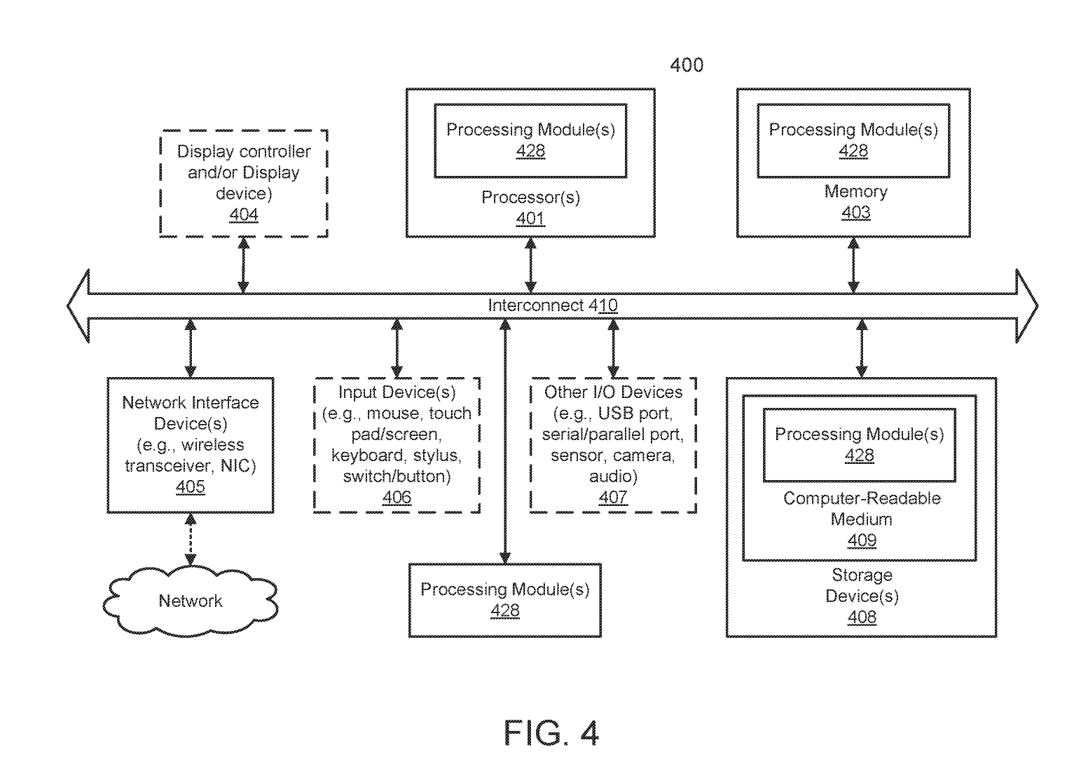

Data processing systems 100, inference model manager 102 (and/or components thereof) may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

While illustrated in FIG. 1A as including a limited number of specific components, a system in accordance with an embodiment may include fewer, additional, and/or different components than those illustrated therein.

Turning to FIG. 1B, a diagram illustrating components of a data processing system in accordance with an embodiment is shown. The components of the data processing system shown in FIG. 1B may be similar to those of the system shown in FIG. 1A.

To provide computer-implemented services, data processing system 100A may include any quantity of hardware resources 150. Hardware resources 150 may be in-band hardware components, and may include a processor operably coupled to memory, storage, channel cards, and/or other hardware components.

The processor may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, these entities may subsequently compromise the operation of the applications. For example, if various drivers and/or the communication stack are compromised, communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100A) to another device via any number of intermediate networks (e.g., via wired/wireless channels 176 that are part of the networks).

To reduce the likelihood of the applications and/or other in-band entities from being indirectly compromised, data processing system 100A may include management controller 152 and network module 160. Each of these components of data processing system 100A is discussed below.

Management controller 152 may be implemented, for example, using a system on a chip or other type of independently operating computing device (e.g., independent from the in-band components, such as hardware resources 150, of a host data processing system 100A). Management controller 152 may provide various management functionalities for data processing system 100A. For example, management controller 152 may monitor various ongoing processes performed by the in-band components, may manage power distribution, may participate in thermal management, and/or other may perform other functions, such as managing operation of channel cards operably connected to data processing system 100A and, subsequently, operation of data processing system 100A with respect to the channel cards.

To do so, management controller 152 may be operably connected to various components via sideband channels 174 (in FIG. 1B, a limited number of sideband channels are included for illustrative purposes, it will be appreciated that management controller 152 may communicate with other components via any number of sideband channels). The sideband channels may be implemented using separate physical channels, and/or with a logical channel overlay over existing physical channels (e.g., logical division of in-band channels). The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, sideband channels 174 may facilitate communications between management controller 152 and hardware resources 150 so that management controller 152 may identify standard and/or non-standard functions of channel cards added to data processing system 100A, modify configurations of the channel cards, modify configurations of software hosted by any of hardware resources 150, and/or otherwise manage functionality of hardware resources 150.

To reduce the likelihood of indirect compromise of an application hosted by hardware resources 150, management controller 152 may enable information from other devices to be provided to the application without traversing the network stack and/or management entities of hardware resources 150. To do so, the other devices may direct communications including the information to management controller 152. Management controller 152 may then, for example, send the information via sideband channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similarly, processes may be used to facilitate outbound communications from the applications.

Management controller 152 may be operably connected to communication components of data processing system 100A via separate channels (e.g., 172) from the in-band components, and may implement or otherwise utilize a distinct and independent network stack (e.g., TCP/IP). Consequently, management controller 152 may communicate with other devices independently of any portion of the in-band components (e.g., does not rely on any hosted software, hardware components, etc.). Accordingly, compromise of any of hardware resources 150 and hosted component may not result in indirect compromise of any management controller 152, and entities hosted by management controller 152.

To facilitate communication with other devices, data processing system 100A may include network module 160. Network module 160 may provide communication services for in-band components and out-of-band components (e.g., management controller 152) of data processing system. Network module 160 may, for example, host a transmission control protocol/internet protocol (TCP/IP) stack to facilitate network communications via in-band and/or out-of-band communication channels. To do so, network module 160 may include traffic manager 162 and interfaces 164.

Traffic manager 162 may include functionality to (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints.

For example, an out-of-band communication channel (e.g., 172) that services management controller 152 and an in-band communication channel (e.g., 170) that services hardware resources 150 may run through network module 160. Therefore, other entities may address communications to hardware resources 150 via the in-band communication channel (e.g., 170) and to management controller 152 via the out-of-band communication channel (e.g., 172).

When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a Wi-Fi card, a wireless local area network card, a wired local area network card, an optical communication card, and/or other types of communication components. These components may support any number of wired/wireless channels 176.

Thus, from the perspective of an external device, the in-band components and the out-of-band components of data processing system 100A may appear to be two independent network entities, that may independently addressable, and otherwise unrelated to one another.

To facilitate management of data processing system 100A over time, hardware resources 150, management controller 152 and/or network module 160 may be positioned in separately controllable power domains. By being positioned in these separately power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., power rail 184, power rail 186) that power the respective power domains. Power from the power source (e.g., a power supply, battery, etc.) may be selectively provided to the separate power rails to selectively power the different power domains. A power manager (e.g., 182) may manage power from power source 180, and power may be supplied via the power rails. Management controller 152 may cooperate with power manager 182 to manage supply of power to these power domains. Management controller 152 may communicate with power manager 182 via sideband channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

Turning to FIG. 1C, a diagram illustrating hardware resources 150 in accordance with an embodiment is shown. The components of hardware resources 150 shown in FIG. 1C may be similar to those of the system shown in FIGS. 1A-1B.

Hardware resources 150 may include any number of hardware components (e.g., memory, processors, channel cards). For example, hardware resources 150 may include any number of channel cards 154 (e.g., 154A-154N) and hardware components 156 (e.g., hardware components other than the channel cards). Channel cards 154 may include expansion cards and/or adapter cards that may add specific functions to data processing system 100A. Each channel card of channel cards 154 may be designed to perform a specific task and/or provide additional capabilities to data processing system 100A (e.g., beyond what other hardware components such as a motherboard of data processing system 100A may offer). For example, channel cards 154 may include graphics processing units (GPUs), network interface cards (NICs), storage controller cards, wireless network cards, Universal Serial Bus (USB) expansion cards, and/or other types of cards.

Channel cards 154 may include any number of stock channel cards (e.g., installed by and/or manufactured by a manufacturer of data processing system 100A) and/or aftermarket channel cards (e.g., added by a user of data processing system 100A) and, therefore, may include a heterogeneous set of channel cards. Channel cards 154 may function in cooperation with other components of hardware resources 150.

Hardware components 156 may host applications and/or other software, and may store and/or execute instructions provided by the applications and/or the software in order to facilitate provision of a computer-implemented service. For example, any of hardware components 156 may host a management controller agent (e.g., a software application) responsible for obtaining operation information, typification data, and/or otherwise monitoring operation of channel cards 154 and hardware components 156. The management controller agent may provide the operation information and/or typification data to the management controller (e.g., via sideband channels).

To further clarify embodiments disclosed herein, an interaction diagram in accordance with an embodiment is shown in FIG. 2. This interaction diagram may illustrate how data may be obtained and used within the system of FIGS. 1A-1C.

In the interaction diagram, processes performed by and interactions between components of a system in accordance with an embodiment are shown. In the diagram, components of the system are illustrated using a first set of shapes (e.g., 102, 152, etc.), located towards the top of each figure. Lines descend from these shapes. Processes performed by the components of the system are illustrated using a second set of shapes (e.g., 206, 210, etc.) superimposed over these lines. Interactions (e.g., communication, data transmissions, etc.) between the components of the system are illustrated using a third set of shapes (e.g., 200, 202, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 200 may occur prior to the interaction labeled as 202. However, it will be appreciated that the processes and interactions may be performed in different orders, any may be omitted, and other processes or interactions may be performed without departing from embodiments disclosed herein.

Communication channels over which information is transmitted during the interactions are represented using double-sided arrows located near the bottom of FIG. 2 (e.g., channel 172, sideband channels 174).

Turning to FIG. 2, an interaction diagram in accordance with an embodiment is shown. The interaction diagram may illustrate processes and interactions that may occur during updating operation of a data processing system using an inference model.

Consider a scenario in which a non-standard channel card (e.g., channel card 154A) is operably connected to a data processing system. To determine whether operation of the data processing system (e.g., 100A shown in FIG. 1A-1C) is to be updated, management controller 152 may obtain data processing system typification data from hardware components 156 and channel card typification data from channel card 154A. To do so, management controller 152 may request the typification data (not shown) and may receive the typification data from hardware resources 150 in response to the request.

At interaction 200, the data processing system typification data may be provided to management controller 152 by hardware components 156. Hardware components 156 may include any hardware components of hardware resources 150 (e.g., processors, memory module, channel cards) other than channel card 154A. Data processing system typification data may include identifying information for the data processing system such as: (i) a number and type of hardware components of the data processing system, (ii) software applications hosted by hardware components 156, (iii) functions provided by hardware components 156 and/or software applications hosted thereon, (iv) modifiable configuration settings for the hardware components and/or software components, and/or (v) other information.

For example, the data processing system typification data may be generated and provided to management controller 152 via (i) transmission via a message, (ii) storing in a storage with subsequent retrieval by management controller 152, (iii) via a publish-subscribe system where management controller 152 subscribes to updates from hardware components 156 thereby causing a copy of the data processing system typification data to be propagated to management controller 152, and/or via other processes. The data processing system typification data may be provided to management controller 152 via side band channels 174. By providing the data processing system typification data to management controller 152, management controller 152 may aggregate the data processing system typification data with channel card typification data to be forwarded to inference model manager 102 as system typification data.

At interaction 202, the channel card typification data may be provided to management controller 152 by channel card 154A. Channel card 154A may be a hardware component of hardware resources 150 and may be a non-standard channel card. Channel card 154A may provide standard functions based on an industry standard for a class of channel card with which channel card 154A is compliant and at least one additional non-standard feature. The class of the channel card may indicate, for example, that channel card 154A is a graphics processing unit (GPU).

The channel card typification data may include at least one of: (i) numbers and types of hardware components of the channel card (e.g., processors, memory modules), (ii) an enumeration of functions provided by the channel card (e.g., a labeled list of standard and non-standard functions), and/or (iii) other information about channel card 154A.

For example, the channel card typification data may be generated and provided to management controller 152 via (i) transmission via a message, (ii) storing in a storage with subsequent retrieval by management controller 152, (iii) via a publish-subscribe system where management controller 152 subscribes to updates from channel card 154A thereby causing a copy of the channel card typification data to be propagated to management controller 152, and/or via other processes. The channel card typification data may be provided to management controller 152 via sideband channels 174. By providing the channel card typification data to management controller 152, management controller 152 may aggregate the data processing system typification data with channel card typification data to be forwarded to inference model manager 102 as system typification data.

At interaction 204, the system typification data may be provided to inference model manager 102 by management controller 152. The system typification data may include at least the data processing system typification data and the channel card typification data and may be aggregated by management controller 152.

For example, the system typification data may be generated and provided to inference model manager 102 via (i) transmission via a message, (ii) storing in a storage with subsequent retrieval by inference model manager 102, (iii) via a publish-subscribe system where inference model manager 102 subscribes to updates from management controller 152 thereby causing a copy of the system typification data to be propagated to inference model manager 102, and/or via other processes. The system typification data may be provided to inference model manager 102 via channel 172 (e.g., an out-of-band communication channel). By providing the system typification data to inference model manager 102, inference model manager 102 may obtain operation update tasks for the data processing system using an inference model and the system typification data as ingest for the inference model.

To obtain the operation update tasks, inference model manager 102 may perform inference generation process 206. During inference generation process 206, the system typification data may be used as ingest for an inference model. The inference model may be trained to generate inferences based on typification data for data processing systems and/or typification data for channel cards. The inferences generated by the inference model may include operation update tasks. The operation update tasks may include actions that, when implemented by a management entity (e.g., management controller 152) for a data processing system, may increase a likelihood of the data processing system and/or a channel card operably connected to the data processing system operating as desired by a user of the data processing system.

The inference model may be based on historic operation information for other data processing systems that hosted other channel cards of a similar typification to a typification of the channel card. Therefore, the inference model may be used to manage operation of any number of data processing systems throughout a distributed environment.

The typification of the channel card may be based on the typification data for the channel card. For example, similar channel cards (e.g., channel cards with functionality and/or hardware components that match to a degree that meets a threshold for similarity) may be manufactured by different manufacturers. However, the similar channel cards may be likely to respond in a substantially similar manner to operation update tasks.

In an embodiment, channel cards respond in a substantially similar manner to operation update tasks when an outcome of the operation update tasks for a first channel card of the channel cards is within a one percent deviation of an outcome of the operation update tasks for a second channel card of the channel cards.

In an embodiment, channel cards respond in a substantially similar manner to operation update tasks when an outcome of the operation update tasks for a first channel card of the channel cards is within a three percent deviation of an outcome of the operation update tasks for a second channel card of the channel cards.

In an embodiment, channel cards respond in a substantially similar manner to operation update tasks when an outcome of the operation update tasks for a first channel card of the channel cards is within a five percent deviation of an outcome of the operation update tasks for a second channel card of the channel cards.

Therefore, similar channel cards may be clustered based on their typification data to obtain clusters of channel cards and a channel card (e.g., 154A) may be assigned a type (e.g., a typification) based on a cluster to which it was assigned. By ingesting the typification data for the channel card and the typification data for the data processing system, the inferences generated by the inference model may be applicable to a variety of different systems including channel cards and data processing systems manufactured by different manufacturers.

A typification for the data processing system may be obtained based on similar methods as described for obtaining a typification for the channel card.

Typified data processing systems and typified channel cards may be monitored over time (e.g., by management controller 152) to obtain operation information indicating an impact of implementing operation update tasks. For example, one or more operation update tasks may be performed to modify operation of a data processing system and/or a channel card operably connected to the data processing system. Following implementation of the operation update tasks, operation information may be obtained.

The operation information may include: (i) memory consumption history for the channel card (e.g., an amount of memory utilized by the channel card at various times and/or during performance of various tasks), (ii) CPU consumption history for the channel card (e.g., processor cycles utilized as part of tasks performed and/or managed by the channel card), (iii) power utilization history for the channel card (e.g., power drawn by the channel card at various times and/or while performing various tasks), (iv) thermal dynamics history for the channel card (e.g., temperature information for the channel card over time, thermal management resources consumed by the channel card), (v) error history for the channel card (e.g., a log of timestamped error messages and contents of the error messages), (vi) security vulnerability history for the channel card (e.g., security alerts and/or current security settings for the channel card), (vii) current configurations of the channel card (e.g., communication protocols, workload distributions), and/or (viii) other data.

Therefore, the historic operation information may include any amount of operation information obtained from any number of data processing systems and/or any number of channel cards over a duration of time. The historic operation information may be obtained in response to operation update tasks being performed and/or for other reasons.

The historic operation information may, therefore, include: (i) a first portion for one of the other data processing systems after the one of the other data processing systems updated its operation based on other operation update tasks, and/or (ii) any number of additional portions for additional data processing systems. The historic operation information may be used to train inference models and/or update existing inference models by supplementing a training data set for the inference models using the historic operation information and/or data derived from the historic operation information. Refer to the description of FIG. 1A for additional details regarding training and/or updating existing inference models.

The operation update tasks indicated by the inference may include: (i) modifications to methods of interaction (e.g., communication protocols) between the channel card and the other hardware components, (ii) modifications to resource allocation between the channel card and the other hardware components, (iii) modifications to workload distribution between software applications hosted by the channel card and software applications hosted by the other hardware components to complete tasks, and/or (iv) other modifications to configurations of the data processing system and/or the channel card to increase a likelihood that computer-implemented services are provided to users of the data processing system as desired.

At interaction 208, the operation update tasks may be provided to management controller 152 by inference model manager 102. For example, the operation update tasks may be generated and provided to management controller 152 via (i) transmission via a message, (ii) storing in a storage with subsequent retrieval by management controller 152, (iii) via a publish-subscribe system where management controller 152 subscribes to updates from inference model manager 102 thereby causing a copy of the operation update tasks to be propagated to management controller 152, and/or via other processes. The operation update tasks may be provided to management controller via channel 172 (e.g., an out-of-band communication channel). By providing the operation update tasks to management controller 152, management controller 152 may obtain implement the operation update tasks to obtain an updated system.

To implement the operation update tasks, management controller 152 may perform update process 210. Management controller 152 may be separate from and tasked with managing operation of hardware resources 150. During update process 210, management controller 152 may perform actions to directly and/or indirectly modify configurations of channel card 154A and/or the data processing system (e.g., hardware components 156 and software hosted thereon). For example, management controller 152 may provide instructions to the channel card and/or to the other hardware components, the instructions indicating configurations to be modified and/or other tasks to be performed to implement the operation update tasks. In addition, management controller 152 may directly and/or indirectly modify configurations of the channel card and/or other hardware components without providing instructions to be followed by another entity.

Therefore, during update process 210, management controller 152 may: (i) modify communication protocols between channel card 154A and hardware components 156 (e.g., change an allocation of communication links for channel card 154A by the host system), (ii) modify allocations of computing resources of the host system (e.g., allocate additional memory of hardware components 156 for use by channel card 154A), (iii) modify configurations of software hosted by channel card 154A and/or hardware components 156 (e.g., modify workload distribution for cooperative tasks), and/or (iv) perform other actions. The above-mentioned modifications may be performed via interactions over sideband channels 174.

During update process 210, management controller 152 may interact with channel card 154A and/or hardware components 156. For example, a management controller agent (e.g., a software application) may be hosted by hardware components 156 and management controller 152 may interact with the management controller agent to provide instructions for implementation by the management controller agent. Therefore, update process 210 may include interactions 212 and 214.

At interaction 212, instructions may be provided to channel card 154A by management controller 152. For example, the instructions may be generated and provided to channel card 154A via (i) transmission via a message, (ii) storing in a storage with subsequent retrieval by channel card 154A, (iii) via a publish-subscribe system where channel card 154A subscribes to updates from management controller 152 thereby causing a copy of the instructions to be propagated to channel card 154A, and/or via other processes. The instructions be provided to channel card 154A via sideband channels 174. By providing the instructions to channel card 154A, channel card 154A may make modifications to configurations in compliance with the operation update tasks associated with the instructions.

At interaction 214, instructions may be provided to hardware components 156 by management controller 152. For example, the instructions may be generated and provided to hardware components 156 via (i) transmission via a message, (ii) storing in a storage with subsequent retrieval by hardware components 156, (iii) via a publish-subscribe system where hardware components 156 subscribes to updates from management controller 152 thereby causing a copy of the instructions to be propagated to hardware components 156, and/or via other processes. The instructions may be provided to hardware components 156 via sideband channels 174. By providing the instructions to hardware components 156, hardware components 156 may make modifications to configurations in compliance with the operation update tasks associated with the instructions.

By doing so, operation of the data processing system and/or operation of channel card 154A may be updated. By updating the data processing system and/or channel card 154A, a likelihood of providing desired computer-implemented services by the data processing system while operably connected to channel card 154A may be increased.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, processes and interactions shown in FIG. 2, may allow for updates to be performed to a data processing system following identification of a non-standard channel card operably connected to the data processing system. By utilizing an inference model trained based on types of inference models and types of channel cards, operation update tasks may be identified across a range of different channel cards from different manufacturers. The operation update tasks may be implemented to increase a likelihood that configurations of the channel card and configurations of the other hardware components (and software hosted thereon) are compatible (e.g., in a state that allows functions to be performed as desired by a user of the data processing system). Doing so may increase a quality and/or reliability of computer-implemented services provided by the data processing system while operably connected to the non-standard channel card.

As discussed above, the components of FIGS. 1A-1C may perform various methods to manage operation of a data processing system. FIG. 3 illustrates a method that may be performed by the components of FIGS. 1A-1C. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method in accordance with an embodiment is shown. The flow diagram may illustrate various operations performed while modifying operation of a data processing system with respect to a non-standard channel card operably connected to the data processing system. The data processing system may include hardware resources (including any number of channel cards) and a management controller, and may be similar to the data processing system discussed with respect to FIGS. 1A-1C.

At operation 300, typification data for a channel card of the data processing system and typification data for the data processing system may be obtained, the channel card being a non-standard channel card.

Obtaining the typification data for the channel card may include: (i) reading the typification data for the channel card from storage, (ii) querying a management entity for the channel card (e.g., a management controller of the data processing system) (e.g., via an out-of-band communication channel) for the typification data for the channel card and receiving the typification data for the channel card as a response from the management entity, (iii) receiving the typification data for the channel card from another entity (e.g., a remote system such as a manufacturer of the channel card), and/or (iv) other methods.

Obtaining the typification data for the data processing system may include: (i) reading the typification data for the data processing system from storage, (ii) querying a management entity for the data processing system (e.g., a management controller of the data processing system) (e.g., via an out-of-band communication channel) for the typification data for the data processing system and receiving the typification data for the data processing system as a response from the management entity, (iii) receiving the typification data for the data processing system from another entity (e.g., a remote system such as a manufacturer of the data processing system), and/or (iv) other methods.

At operation 302, operation update tasks for the data processing system may be obtained using the typification data for the channel card, the typification data for the data processing system, and an inference model. Obtaining the operation update tasks may include: (i) feeding the typification data for the data processing system and the typification data for the channel card into the inference model, (ii) obtaining, as output from the inference model, the operation update tasks. Obtaining the operation update tasks may also include: (i) selecting the inference model based on a typification of the channel card and/or a typification of the data processing system (e.g., as indicated by the typification data for the channel card and/or the typification data for the data processing system), (ii) providing the typification data for the channel card and the typification data for the data processing system to another entity responsible for hosting and operating the inference model, and/or (iii) other methods.

At operation 304, operation of the data processing system and/or operation of the channel card may be updated to obtain an updated system. Modifying the operation of the data processing system and/or the operation of the channel card may include: (i) directly and/or indirectly modifying operation of the data processing system and/or operation of the channel card, (ii) providing instructions to another entity responsible for implementing the operation update tasks, and/or (iii) other methods.

Modifying the operation of the data processing system and/or the operation of the channel card may include: (i) modifying a manner in which the channel card interacts with the other hardware components of the data processing system (e.g., via updating communication protocols, via modifying an allocation of communication links to the channel card), (ii) modifying resource allocation between the channel card and the other hardware components (e.g., modifying an allocation of host system memory for use by the channel card, modifying a quantity of processor cycles of the host system allocated to the channel card), (iii) modifying a workload distribution for tasks to be completed by software hosted by the channel card and/or the other hardware components, and/or (iv) other methods.

At operation 306, computer-implemented services may be provided using the updated system. The computer-implemented services may be provided based on cooperative operation of the channel card and the other hardware components in order to perform functions desired by a user of the data processing system. For example, a channel card may be a graphics card and providing the computer-implemented services using the updated system may include providing gaming services to a user based, at least in part, on functionality of the graphics card.

The method may end following operation 306.

Thus, modifications may be made to data processing systems based on types of channel cards and types of data processing systems to increase a likelihood of computer-implemented services being provided as desired. As non-standard channel cards may have configurations that are unknown to other hardware components of the data processing system, modifying the data processing system (e.g., modifying configurations of channel cards, modifying a manner in which other hardware components interact with the channel cards, modifying the configurations of the data processing system) may increase a likelihood that the hardware components may cooperatively interact as desired to provide computer-implemented services to users.

Any of the components illustrated in FIGS. 1A-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., basic input/output system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output system (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
obtaining, from a management controller of the data processing system via an out-of-band communication channel, typification data for a channel card of the data processing system and typification data for the data processing system, the channel card being a non-standard channel card;
obtaining, using the typification data for the channel card, the typification data for the data processing system and an inference model, operation update tasks for the data processing system, wherein the inference model is based on historic operation information for other data processing systems that hosted other channel cards of a similar typification to a typification of the channel card;
updating, using the operation update tasks, operation of the data processing system and/or the channel card to obtain an updated system; and
providing computer-implemented services using the updated system.

2. The method of claim 1, wherein the historic operation information comprises:
a first portion for one of the other data processing systems after the one of the other data processing systems updated its operation based on other operation update tasks.

3. The method of claim 2, wherein the first portion comprises:
memory consumption history for the channel card;
central processing unit consumption history for the channel card;
power utilization history for the channel card;
thermal dynamics history for the channel card;
error history for the channel card;
security vulnerability history for the channel card; and
current configurations of the channel card.

4. The method of claim 1, wherein the typification data for the channel card is usable to cluster channel cards from different manufacturers into clusters of channel cards, and each of the clusters of channel cards being likely to respond in a same manner to the operation update tasks.

5. The method of claim 4, wherein the typification data comprises numbers and types of hardware components of the channel card.

6. The method of claim 4, wherein the typification data comprises an enumeration of functions provided by the channel card.

7. The method of claim 1, wherein the updating is performed by the management controller via sideband channels of the data processing system.

8. The method of claim 1, wherein the operation update tasks are provided to the management controller by a remote system via the out-of-band communication channel.

9. The method of claim 1, wherein the management controller is separate from and tasked with managing operation of hardware resources of the data processing system, the hardware resources comprising the channel card.

10. The method of claim 9, wherein the data processing system comprises a network module adapted to separately advertise network endpoints for the management controller and hardware resources of the data processing system, the network endpoints being usable by a remote system to address communications to the hardware resources using an in-band communication channel and the management controller using the out-of-band communication channel.

11. The method of claim 10, wherein the management controller and the network module are on separate power domains from the hardware resources so that the management controller and the network module are operable while the hardware resources are inoperable.

12. The method of claim 10, wherein the out-of-band communication channel runs through the network module, and an in-band communication channel that services the hardware resources also runs through the network module.

13. The method of claim 10, wherein the network module hosts a transmission control protocol/internet protocol (TCP/IP) stack to facilitate network communications via the out of band communication channel.

14. The method of claim 1, wherein the non-standard channel card is configured to perform at least one non-standard function based on standard functions of a class of the channel card.

15. A non-transitory machine-readable medium having instructions stored therein, which when executed by a processor, cause the processor to perform operations for managing operation of a data processing system, the operations comprising:
obtaining, from a management controller of the data processing system via an out-of-band communication channel, typification data for a channel card of the data processing system and typification data for the data processing system, the channel card being a non-standard channel card;
obtaining, using the typification data for the channel card, the typification data for the data processing system and an inference model, operation update tasks for the data processing system, wherein the inference model is based on historic operation information for other data processing systems that hosted other channel cards of a similar typification to a typification of the channel card;
updating, using the operation update tasks, operation of the data processing system and/or the channel card to obtain an updated system; and
providing computer-implemented services using the updated system.

16. The non-transitory machine-readable medium of claim 15, wherein the historic operation information comprises:
a first portion for one of the other data processing systems after the one of the other data processing systems updated its operation based on other operation update tasks.

17. The non-transitory machine-readable medium of claim 16, wherein the first portion comprises:
memory consumption history for the channel card;
central processing unit consumption history for the channel card;
power utilization history for the channel card;
thermal dynamics history for the channel card;
error history for the channel card;
security vulnerability history for the channel card; and
current configurations of the channel card.

18. A data processing system, comprising:
a processor; and
a memory coupled to the processor to store instructions, which when executed by the processor, cause the processor to perform operations, the operations comprising:
obtaining, from a management controller of the data processing system via an out-of-band communication channel, typification data for a channel card of the data processing system and typification data for the data processing system, the channel card being a non-standard channel card;
obtaining, using the typification data for the channel card, the typification data for the data processing system and an inference model, operation update tasks for the data processing system, wherein the inference model is based on historic operation information for other data processing systems that hosted other channel cards of a similar typification to a typification of the channel card;
updating, using the operation update tasks, operation of the data processing system and/or the channel card to obtain an updated system; and
providing computer-implemented services using the updated system.

19. The data processing system of claim 18, wherein the historic operation information comprises:
a first portion for one of the other data processing systems after the one of the other data processing systems updated its operation based on other operation update tasks.

20. The data processing system of claim 19, wherein the first portion comprises:
memory consumption history for the channel card;
central processing unit consumption history for the channel card;
power utilization history for the channel card;
thermal dynamics history for the channel card;
error history for the channel card;
security vulnerability history for the channel card; and
current configurations of the channel card.
